(19) United States
(12) Patent Application Publication
(10) Pub. No.: US 2006/0103451 A1
(43) Pub. Date: May 18, 2006

(54) Tunable reference voltage generator

(76) Inventors: Jong-Hyoung Lim, Seoul (KR); Kwang-Il Park, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/281,347

(22) Filed: Nov. 16, 2005

(30) Foreign Application Priority Data
Nov. 17, 2004 (KR) 2004-93995

(51) Int. Cl. G05F 1/10

(52) U.S. Cl. 327/540

(57) ABSTRACT

A reference voltage generator generates an output reference voltage having various voltage levels. The reference voltage generator includes an amplifier to amplify a difference between a feedback reference voltage and a feedback voltage to generate an amplified signal, a current driving circuit to provide a current signal in response to the amplified signal, a scaler circuit to generate feedback voltage signals and reference voltage signals in response to the current signal, and a feedback voltage selecting circuit to select one of the feedback voltage signals in response to a control signal, and to provide the selected feedback voltage signal to the operational amplifier as the feedback voltage.

### CROSS-REFERENCE TO RELATED APPLICATIONS

This application claims priority to Korean Patent Application No. 2004-93995 filed on Nov. 17, 2004, the contents of which are herein incorporated by reference in its entirety.

### BACKGROUND OF THE INVENTION

1. Field of the Invention

This application relates to semiconductor devices, and particularly to reference voltage generators of semiconductor devices.

2. Description of the Related Art

As circuits with various functions have been included in a semiconductor device, various reference voltages have been needed.

FIG. 1 is a circuit diagram illustrating a conventional reference voltage generator. FIG. 1 shows a reference voltage generator generating a reference voltage having sixteen different levels.

Referring to FIG. 1, the conventional reference voltage generator includes a reference voltage generating circuit 110, an amplifying circuit 120, a current driving circuit 130, a scaler circuit 140, and an output voltage selecting circuit 150. The scaler circuit 140 includes a reference resistor RB and sixteen resistors R0 to R15, and generates a voltage that may have sixteen different levels. The output voltage selecting circuit 150 selects one of output voltages of the scaler circuit 140, and outputs the selected one as an internal reference voltage VREFI.

The reference voltage generator of FIG. 1 needs to have seventeen resistors and a 16×1 multiplexer to generate a reference voltage that may have sixteen different levels. More resistors and a different multiplexer are required to generate a reference voltage that may have more levels. For example, 257 resistors and an 8-bit multiplexer are needed to generate a reference voltage that may have 256 different levels using the reference voltage generator of FIG. 1.

However, the reference voltage generators described above occupy too much area on a semiconductor chip because of the large amount of resistors and the large multiplexer. Accordingly, a reference voltage generator occupying less area when the reference voltage generator is implemented in a semiconductor integrated circuit is needed.

### SUMMARY

An embodiment includes a reference voltage generator includes an amplifier to amplify a difference between a feedback reference voltage and a feedback voltage to generate an amplified signal, a current driving circuit to provide a current signal in response to the amplified signal, a scaler circuit to generate feedback voltage signals and reference voltage signals in response to the current signal, and a feedback voltage selecting circuit to select one of the feedback voltage signals in response to a control signal, and to provide the selected feedback voltage signal to the operational amplifier as the feedback voltage.

A further embodiment includes a method of generating a reference voltage including selecting a feedback line from a scaler circuit, the scaler circuit having a reference voltage line, and adjusting an input of the scaler circuit such that a voltage on the selected feedback line becomes substantially equal to a feedback reference voltage.

Another embodiment includes a reference voltage generator including a scaler circuit to generate feedback voltage signals and reference voltage signals, a multiplexer to select one of the feedback voltage signals, and a driver to drive the scaler circuit such that a voltage of the selected feedback voltage signal is substantially equal to a feedback reference voltage.

### BRIEF DESCRIPTION OF THE DRAWINGS

The foregoing and other features and advantages of the invention will be apparent from the more particular descriptions of example embodiments of the invention, as illustrated in the accompanying drawings. The drawings are not necessarily to scale, emphasis instead being placed upon illustrating the principles of the invention. Like reference characters refer to like elements throughout the drawings.

FIG. 1 is a circuit diagram illustrating a conventional reference voltage generator.

FIG. 2 is a circuit diagram illustrating a reference voltage generator according to an example embodiment.

FIG. 3 is a circuit diagram illustrating an example of a scaler circuit shown in FIG. 2.

FIG. 4 is a circuit diagram illustrating a reference voltage generator according to another embodiment of the present invention.

### DETAILED DESCRIPTION

Detailed illustrative embodiments of the invention are disclosed herein. However, specific structural and functional details disclosed herein are merely representative for purposes of describing embodiments to enable one skilled in the art to understand the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope. In addition, as used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

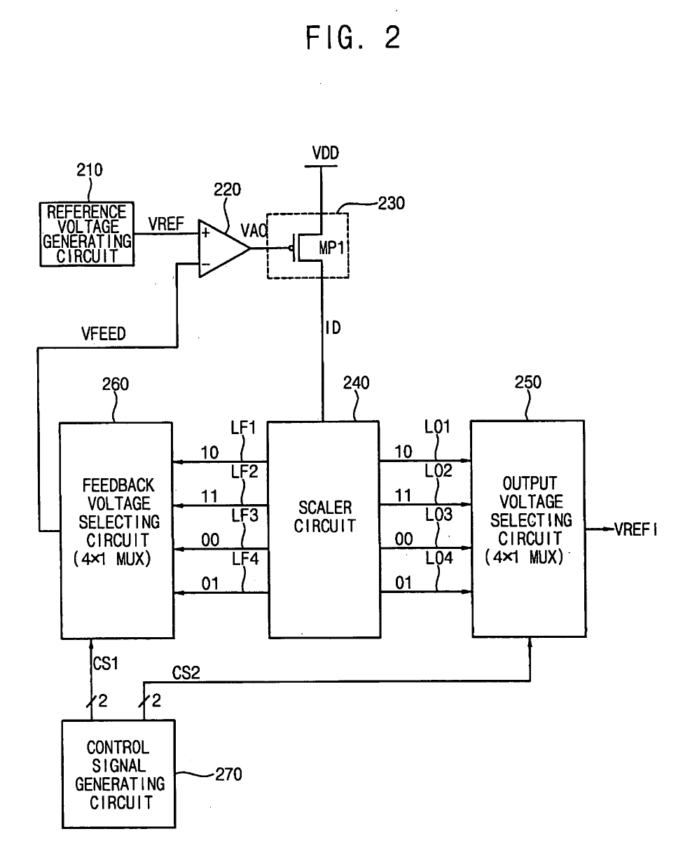

FIG. 2 is a circuit diagram illustrating a reference voltage generator according to an example embodiment. The reference voltage generator is capable of generating sixteen discrete reference voltages. Referring to FIG. 2, the reference voltage generator includes a reference voltage generating circuit 210, an operational amplifier 220, a current driving circuit 230, a scaler circuit 240, a feedback voltage selecting circuit 260, an output voltage selecting circuit 250 and a control signal generating circuit 270.

The reference voltage generating circuit 210 may be implemented using a band-gap reference generating circuit that is well known to one of ordinary skill in the art, and generates the first reference voltage VREF.

The operational amplifier 220 has a first input terminal (+) for receiving a first reference voltage VREF and a second input terminal (−) for receiving a feedback voltage VFEED, and amplifies a difference between the first reference voltage VREF and the feedback voltage VFEED to generate an amplified signal VAO.

The current driving circuit 230 generates a first current signal ID in response to the amplified signal VAO and supplies the first current signal ID to the scaler circuit 240. The current driving circuit 230 may be comprised of a PMOS transistor MP1.

The scaler circuit 240 feedback lines LF1 to LF4 and output lines LO1 to LO4, and generates voltage signals in response to the first current signal ID for the feedback lines LF1 to LF4 and the output lines LO1 to LO4.

The feedback voltage selecting circuit 260 selects one voltage signal of voltage signals of the feedback lines LF1 to LF4 in response to a first control signal CS1, and provides the selected voltage signal to the second input terminal (−) of the operational amplifier 220.

The output voltage selecting circuit 250 selects one voltage signal of voltage signals of the output lines LO1 to LO4 in response to a second control signal CS2 and outputs the selected voltage signal as a second reference voltage VREFI.

The control signal generating circuit 270 generates the first control signal CS1 and the second control signal CS2.

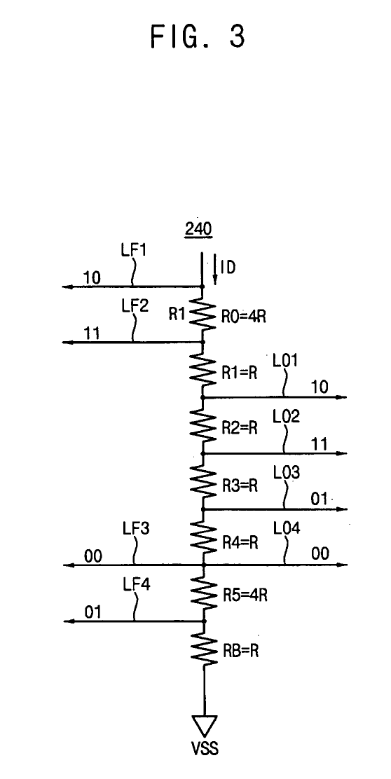

FIG. 3 is a circuit diagram illustrating an example of a scaler circuit shown in FIG. 2. Referring to FIG. 3, the scaler circuit 240 includes resistors R0 to R5 and RB connected in series between a drain of the PMOS transistor MP1 and the ground VSS.

The feedback line LF1 is coupled to the first terminal of the resistor R0, and the feedback line LF2 is coupled to the second terminal of the resistor R0. The feedback line LF3 is coupled to the first terminal of the resistor R5, and the feedback line LF4 is coupled to the second terminal of the resistor R5. Further, the output line LO1 is coupled to the first terminal of the resistor R2, and the output line LO2 is coupled to the second terminal of the resistor R2. The output line LO3 is coupled to the first terminal of the resistor R4, and the output line LO4 is coupled to the second terminal of the resistor R4. The resistor RB and the resistors R1 to R4 may have the same resistance, and the resistor R0 and the resistor R5 may have resistance that is four times larger than the resistance of the resistor RB.

Hereinafter, referring to FIG. 2 and FIG. 3, the operation of the reference voltage generating circuit will be described.

The reference voltage generating circuit of FIG. 2 selects one of the discrete voltage levels to output the second reference voltage VREFI in response to the first reference voltage VREF that is generated by the reference voltage generating circuit 210. The second reference voltage VREFI may be supplied to circuit blocks that need various reference voltages included in semiconductor integrated circuits. FIG. 2 illustrates a reference voltage generator that generates sixteen discrete reference voltages.

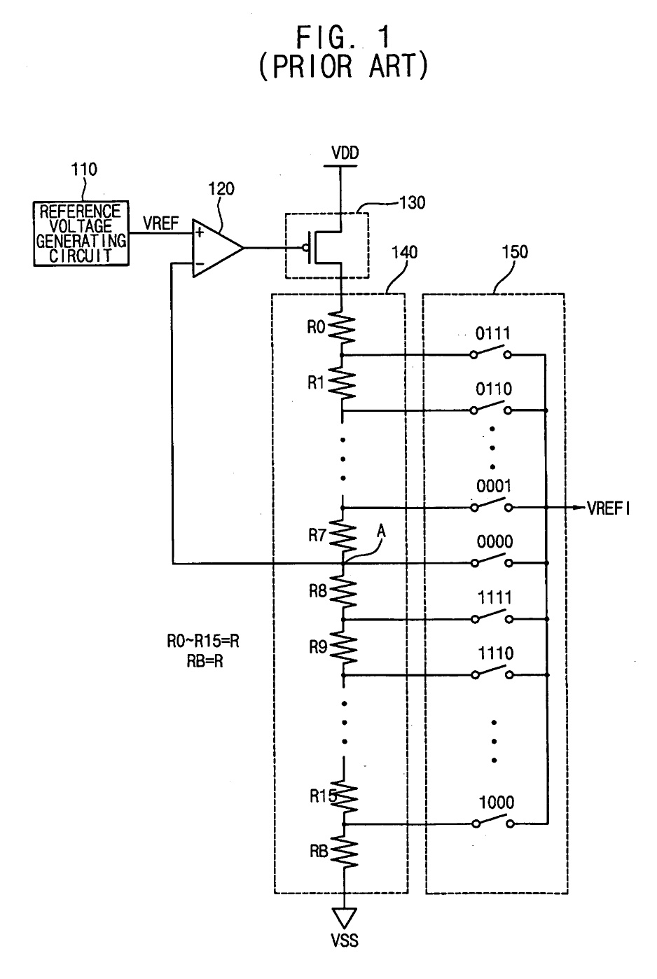

As described above, referring to FIG. 1, when the conventional reference voltage generator is used, seventeen resistors and a 16×1 multiplexer are needed to generate sixteen discrete reference voltages. However, the reference voltage generator of FIG. 2 can decrease the amount of resistors needed to scale a voltage and decrease the size of a multiplexer used to select voltages.

The scaler circuit 240 includes transistors R0˜R5 and RB, feedback lines LF1 to LF4 and output lines LO1 to LO4. The feedback lines LF1 to LF4 are coupled to the feedback voltage selecting circuit 260, and the output lines LO1 to LO4 are coupled to the output voltage selecting circuit 250. The feedback voltage selecting circuit 260 selects one of the four feedback lines LF1 to LF4 and connects the selected line to the inverted input terminal (−) of the operational amplifier 220 in response to two bits of the first control signal CS1. The output voltage selecting circuit 250 selects one of the four output lines LO1 to LO4 and connects the selected line to the output line of the reference voltage generator in response to two bits of the second control signal CS2. Therefore, one of the voltage levels on the four output lines LO1 to LO4 is selected and outputted as the second reference voltage VREFI. The first control signal CS1 may be represented by upper two bits of a 4-bit data and the second control signal may be represented by lower two bits of the 4-bit data.

For example, when a code of the first control signal CS1 is 00 and a code of the second control signal CS2 is 00, the feedback line LF3 is connected to the inverted input terminal (−) of the operational amplifier 220. At this time, the voltage on the feedback line LF3 becomes the feedback voltage VFEED. Because of the characteristic of the operational amplifier 220, the voltage VFEED of the inverted input terminal becomes equal to the voltage VREF of the non-inverted input terminal. Therefore, the voltage on the feedback line LF3 becomes equal to the voltage of the non-inverted input terminal, which is the first reference voltage VREF. Because the second control signal CS2 is 00, the first reference voltage VREF is outputted as the second reference voltage VREFI.

When the voltage dropped across the resistor RB is DV, and when a code of the first control signal CS1 is 00 and a code of the second control signal CS2 is 01, the second reference voltage VREFI becomes the first reference voltage VREF plus the voltage dropped across the resistor R4. That is, VREF+DV is selected and outputted as the second reference voltage VREFI.

When a code of the first control signal CS1 is 11 and a code of the second control signal CS2 is 01, the feedback line LF2 is connected to the inverted input terminal of the operational amplifier 220. At this time, the voltage on the feedback line LF2 becomes the feedback voltage VFEED. Because the second control signal CS2 is 01, the voltage of the connection point between the resistors R3 and R4 is selected and outputted as the second reference voltage VREFI. That is, VREF-3DV is selected and outputted as the second reference voltage VREFI.

As described above, when the feedback lines LF1 to LF4 and the output lines LO1 to LO4 are combined, sixteen discrete voltages can be generated. When the conventional reference voltage generator is used, seventeen resistors and a 16×1 multiplexer are needed to generate sixteen discrete reference voltages using a 4-bit selection code. But, in the example embodiment shown in FIG. 2, two bits of the 4-bit selection code are provided to the feedback voltage selecting circuit 260, and the other two bits of the 4-bit selection code are provided to the output voltage selecting circuit 250 to generate sixteen discrete voltages. The feedback voltage selecting circuit 260 selects one of the four feedback lines LF1 to LF4 to connect the selected line to the inverted input terminal of the operational amplifier 220 in response to two bits of the first control signal CS1. The output voltage selecting circuit 250 selects one of the voltage signals on the four output lines LO1 to LO4 and outputs the selected voltage signal as the second reference voltage VREFI in response to two bits of the second control signal CS2. Therefore, the reference voltage generator according to the example embodiment shown in FIG. 2 uses seven resistors R0 to R5 and RB and two 4×1 multiplexers to generate sixteen discrete voltages.

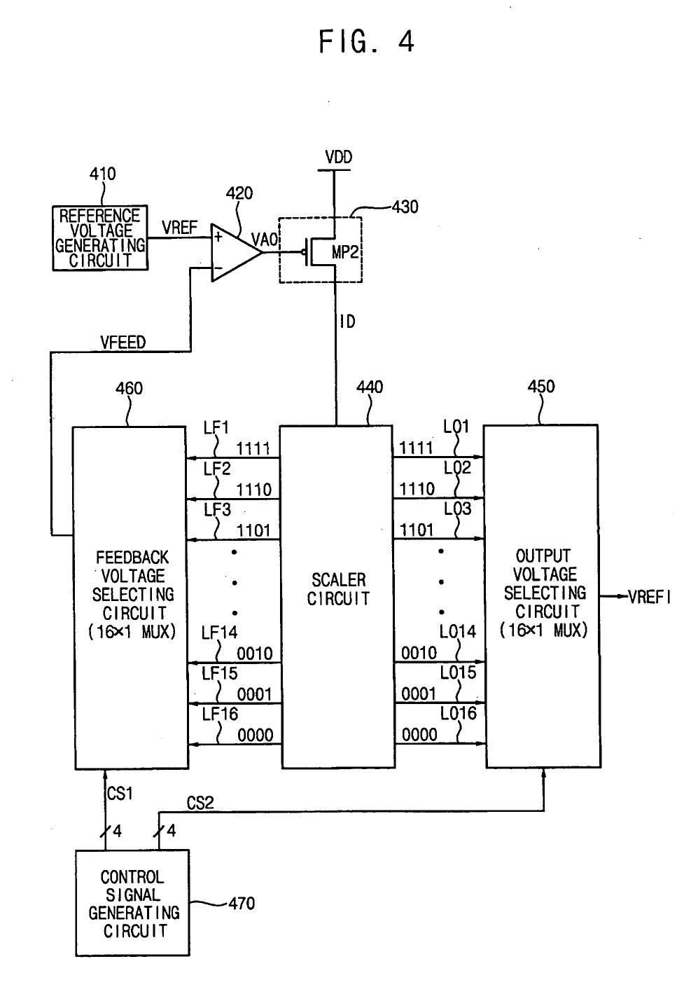

FIG. 4 is a circuit diagram illustrating a reference voltage generator according to another embodiment. The reference voltage generator is capable of generating 256 discrete reference voltages.

Referring to FIG. 4, the reference voltage generator includes a reference voltage generating circuit 410, an operational amplifier 420, a current driving circuit 430, a scaler circuit 440, a feedback voltage selecting circuit 460, an output voltage selecting circuit 450 and a control signal generating circuit 470.

The reference voltage generating circuit 410, the operational amplifier 420 and the current driving circuit 430 included in FIG. 4 are similar to the reference voltage generating circuit 210, the operational amplifier 220 and the current driving circuit 230 included in FIG. 2, respectively. The scaler circuit 440 includes feedback lines LF1 to LF16 and output lines LO1 to LO16, and generates voltage signals in response to the first current signal ID for the feedback lines LF1 to LF16 and the output lines LO1 to LO16.

The feedback voltage selecting circuit 460 selects one of voltage signals of the feedback lines LF1 to LF16 in response to a first control signal CS1, and provides the selected voltage signal to the second input terminal (−) of the operational amplifier 420. The feedback voltage selecting circuit 460 may be implemented using a 16×1 multiplexer.

The output voltage selecting circuit 450 selects one of voltage signals of the output lines LO1 to LO16 in response to a second control signal CS2 and outputs the selected voltage signal as a second reference voltage VREFI. The output voltage selecting circuit 450 may be implemented using a 16×1 multiplexer.

The control signal generating circuit 470 generates the first control signal CS1 and the second control signal CS2.

Hereinafter, the operation of the reference voltage generator of FIG. 4 will be described.

The reference voltage generating circuit of FIG. 4 selects one of the discrete voltage levels to output the second reference voltage VREFI in response to the first reference voltage VREF that is generated by the reference voltage generating circuit 410. The second reference voltage VREFI may be supplied to circuit blocks that need various reference voltages included in semiconductor integrated circuits. FIG. 4 illustrates a reference voltage generator that generates 256 discrete reference voltages.

When the conventional reference voltage generator as shown in FIG. 1 is used, 257 resistors and a 256×1 multiplexer are needed to generate 256 discrete reference voltages. However, the reference voltage generator of FIG. 4 can decrease the amount of resistors needed to scale a voltage and decrease the size of a multiplexer used to select voltages.

The scaler circuit 440 may include resistors connected in series similarly to the scaler circuit 220 of FIG. 2. Further, the scaler circuit 440 includes feedback lines LF1 to LF16 and output lines LO1 to LO16. The feedback lines LF1 to LF16 are coupled to the feedback voltage selecting circuit 460, and the output lines LO1 to LO16 are coupled to the output voltage selecting circuit 450. The feedback voltage selecting circuit 460 selects one of the sixteen feedback lines LF1 to LF16 and connects the selected line to the inverted input terminal (−) of the operational amplifier 420 in response to four bits of the first control signal CS1. The output voltage selecting circuit 450 selects one of the sixteen output lines LO1 to LO16 and connects the selected line to the output line of the reference voltage generator in response to four bits of the second control signal CS2. As a result, one of the voltage levels on the sixteen output lines LO1 to LO16 is selected and outputted as the second reference voltage VREFI. The first control signal CS1 may be represented by upper four bits of a 16-bit data and the second control signal may be represented by lower four bits of the 16-bit data.

As described above, when the feedback lines LF1˜LF16 and the output lines LO1˜LO16 are combined, 256 discrete voltages can be generated. When the conventional reference voltage generator is used, 257 resistors and a 256×1 multiplexer are needed to generate 256 discrete reference voltages using an 8-bit selection code. But, in the example embodiment shown in FIG. 4, four bits of the 8-bit selection code are provided to the feedback voltage selecting circuit 460, and the other four bits of the 8-bit selection code are provided to the output voltage selecting circuit 450 to generate 256 discrete voltages. The feedback voltage selecting circuit 460 selects one of the sixteen feedback lines LF1 to LF16 and connects the selected line to the inverted input terminal of the operational amplifier 420 in response to four bits of the first control signal CS1. The output voltage selecting circuit 450 selects one of the voltage signals on the sixteen output lines LO1 to LO16 and outputs the selected voltage signal as the second reference voltage VREFI in response to four bits of the second control signal CS2. Therefore, the reference voltage generator according to the example embodiment shown in FIG. 4 uses 127 resistors and two 16×1 multiplexers to generate 256 discrete voltages.

Generally, if 2ⁿ discrete voltages are required, 2^{(N-1)}−1 resistors and simple multiplexers are needed. As a result, when a reference voltage generator as described above is used, for a given number of voltage levels, the number of resistors and the circuit area needed are decreased as compared with conventional reference voltage generators.

A reference voltage generator according an embodiment includes a feedback voltage selecting circuit and an output voltage selecting circuit, and selectively connects one of several feedback lines to an input terminal of an operational amplifier and outputs the voltage on output lines selectively to generate reference voltages having various voltage levels. As a result, the number of possible discrete levels for an output reference voltage of the reference voltage generator may be greater than the case of the conventional reference voltage generator by changing the location in the scaler circuit to which an input reference voltage is applied.

Accordingly, the reference voltage generator according to an embodiment may generate various levels of reference voltages using a smaller number of resistors than conventional reference voltage generators. Further, the reference voltage generator according to an embodiment may have a more simple circuit structure and occupy less area in a semiconductor integrated circuit than a conventional reference voltage generator.

In some embodiments, output lines of a scaler circuit may be selected to select a reference voltage. The output lines may be referred to as reference voltage lines and the signals on the lines may be referred to as reference voltage signals.

While example embodiments and their advantages have been described in detail, it should be understood that various changes, substitutions and alterations can be made herein without departing from the scope of the invention as defined by the appended claims.

What is claimed is:

1. A reference voltage generator, comprising:
an amplifier to amplify a difference between a feedback reference voltage and a feedback voltage to generate an amplified signal;
a current driving circuit to provide a current signal in response to the amplified signal;
a scaler circuit to generate a plurality of feedback voltage signals and at least one reference voltage signal in response to the current signal; and
a feedback voltage selecting circuit to select one of the feedback voltage signals in response to a first control signal, and to provide the selected feedback voltage signal to the operational amplifier as the feedback voltage.

2. The reference voltage generator of claim 1, further comprising an output voltage selecting circuit constructed and arranged to select one of the at least one reference voltage signals in response to a second control signal, and to output the selected reference voltage signal as the reference voltage.

3. The reference voltage generator of claim 2, the feedback-voltage selecting circuit and the output voltage selecting circuit each further comprise a 4×1 multiplexer.

4. The reference voltage generator of claim 2, the feedback voltage selecting circuit and the output voltage selecting circuit each further comprise a 16×1 multiplexer.

5. The reference voltage generator of claim 2, wherein the output voltage selecting circuit further constructed and arranged to output the reference voltage substantially equal to one of sixteen different voltages for each combination of the selected feedback voltage signals and the selected reference voltage signals.

6. The reference voltage generator of claim 1, wherein each of the first control signal and the second control signal is a 2-bit signal.

7. The reference voltage generator of claim 6, wherein the first control signal is represented by upper two bits of a 4-bit data and the second control signal is represented by lower two bits of the 4-bit data.

8. The reference voltage generator of claim 1, wherein the scaler circuit includes a plurality of resistors connected in series between the current driving circuit and a supply voltage.

9. The reference voltage generator of claim 8, wherein the scaler circuit further comprises:
sixteen feedback lines; and
sixteen output lines.

10. The reference voltage generator of claim 8, wherein the scaler circuit further comprises:
a first resistor having a first terminal coupled to the current driving circuit;
a second resistor having a first terminal coupled to the second terminal of the first resistor;
a third resistor having a first terminal coupled to the second terminal of the second resistor;
a fourth resistor having a first terminal coupled to the second terminal of the third resistor;
a fifth resistor having a first terminal coupled to the second terminal of the fourth resistor;
a sixth resistor having a first terminal coupled to the second terminal of the fifth resistor; and
a seventh resistor coupled between the second terminal of the sixth resistor and the supply voltage.

11. The reference voltage generator of claim 10, wherein the scaler circuit further comprises:
four feedback lines; and
four output lines.

12. The reference voltage generator of claim 11, wherein the scaler circuit further comprises:
a first feedback line coupled to the first terminal of the first resistor;
a second feedback line coupled to the second terminal of the first resistor;
a third feedback line coupled to the first terminal of the sixth resistor; and
a fourth feedback line coupled to the second terminal of the sixth resistor.

13. The reference voltage generator of claim 12, wherein the scaler circuit further comprises:
a first output line coupled to the first terminal of the third resistor;
a second output line coupled to the first terminal of the fourth resistor;
a third output line coupled to the first terminal of the fifth resistor; and
a fourth output line coupled to the first terminal of the sixth resistor.

14. The reference voltage generator of claim 13, wherein the seventh resistor and the second to fifth resistors have substantially the same resistance.

15. The reference voltage generator of claim 14, wherein the first resistor and the sixth resistor have a resistance that is about four times greater than the resistance of the seventh resistor.

16. The reference voltage generator of claim 1, wherein the output voltage selecting circuit further constructed and arranged to output the reference voltage substantially equal to one of 256 different voltages for each combination of the selected feedback voltage signals and the selected reference voltage signals.

17. The reference voltage generator of claim 16, wherein each of the first control signal and the second control signal is a 4-bit signal.

18. The reference voltage generator of claim 17, wherein the first control signal is represented by upper four bits of an 8-bit data and the second control signal is represented by lower four bits of the 8-bit data.

19. The reference voltage generator of claim 1, wherein the current driving circuit further comprises a MOS transistor to supply the current signal to the scaler circuit.

20. The reference voltage generator of claim 1, further comprising a feedback reference voltage generator to generate the feedback reference voltage.

21. The reference voltage generator of claim 1, further comprising a control-signal generating circuit to generate the first control signal and the second control signal.

22. A method of generating a reference voltage comprising:
selecting one of a plurality of feedback lines from a scaler circuit, the scaler circuit having at least one reference voltage line; and
adjusting an input of the scaler circuit such that a voltage on the selected feedback line becomes substantially equal to a feedback reference voltage.

23. The method of claim 22, further comprising:
selecting one of the at least one reference voltage lines of the scaler circuit; and
outputting a voltage on the selected output line as the reference voltage.

24. The method of claim 22, wherein selecting the one of the plurality of feedback lines further comprises selecting the one of the plurality of feedback lines in response to a control signal.

25. The method of claim 22, wherein selecting the one of the plurality of feedback lines further comprises selecting the one of the plurality of feedback lines using a multiplexer.

26. A reference voltage generator comprising:
a scaler circuit to generate a plurality of feedback voltage signals and at least one reference voltage signal;
a multiplexer to select one of the feedback voltage signals; and
a driver to drive the scaler circuit such that a voltage of the selected feedback voltage signal is substantially equal to a feedback reference voltage.

27. The reference voltage generator of claim 26, further comprising a second multiplexer to select one of the at least one reference voltage signals as the reference voltage.
